(19) United States
(12) Patent Application Publication
(10) Pub. No.: US 2014/0016077 A1
(43) Pub. Date: Jan. 16, 2014

(54) Display Apparatus

(71) Applicant: AU Optronics Corporation, Hsin-Chu (TW)

(72) Inventor: Cheng-Ying Chou, Hsin-Chu (TW)

(73) Assignee: AU Optronics Corporation, Hsin-Chu (TW)

(21) Appl. No.: 13/898,520

(22) Filed: May 21, 2013

(30) Foreign Application Priority Data
Jul. 12, 2012 (TW) 101125054

(51) Int. Cl. G02F 1/1339

(52) U.S. Cl. CPC G02F 1/1339
USPC 349/153

(57) ABSTRACT

A display apparatus is disclosed. The display apparatus includes a display panel. The display panel includes an upper substrate, a lower substrate, a main sealant, and at least one supporting sealant. The display panel includes an active area and a peripheral circuit area adjacent to the active area. The main sealant is disposed between the upper substrate and the lower substrate. The main sealant is disposed out of the active area to form a sealed area. The sealed area covers the active area and a part of the peripheral circuit area. The at least one supporting sealant is disposed in the sealed area and out of the active area. The distance between at least one side of the main sealant and the active area is different from the distances between the other sides of the main sealant and the active area.

### BACKGROUND OF THE INVENTION

1. Field of the Invention

The invention relates to a display apparatus; in particular, to a display apparatus having different sealant coating designs to reduce the exposed area of effective circuit to prevent the circuit from being damaged and to avoid the ripples shown in the display screen.

2. Description of the Prior Art

With the development of the display technology, in terms of production scale and product applications popularity, the liquid crystal display (LCD) undoubtedly retains its position as the mainstream of the flat panel display technology.

In the conventional liquid crystal display, the area out of the active area on the lower substrate of the display panel is called “a peripheral circuit area”. Because a part of the effective circuit in the peripheral circuit area is not covered by the sealed area formed by the main sealant, the part of the effective circuit will be exposed without any protection; it is called “an exposed area of effective circuit”. When a cutter wheel cuts crack a glass, a lot of glass scraps will be generated and some exposed effective circuit near the cut crack line (an edge of the substrate) will be easily damaged by these glass scraps. Therefore, line defects will be easily generated on the effective circuit and the reliability of the effective circuit will be lowered accordingly.

In addition, ripples are easily generated in the corner of the screen displayed by the conventional display apparatus and the display quality of the liquid crystal display will be seriously affected. The above-mentioned problems are to be overcome.

### SUMMARY OF THE INVENTION

Therefore, the invention provides a display apparatus to solve the above-mentioned problems occurred in the prior arts.

An embodiment of the invention is a display apparatus. In this embodiment, the display apparatus includes a display panel. The display panel includes an upper substrate, a lower substrate, a main sealant, and at least one supporting sealant. The display panel includes an active area and a peripheral circuit area adjacent to the active area. The main sealant is disposed between the upper substrate and the lower substrate. The main sealant is out of the active area to form a sealed area. The sealed area covers the active area and a part of the peripheral circuit area. The at least one supporting sealant is disposed in the sealed area and out of the active area. The distance between at least one side of the main sealant and the active area is different from the distances between the other sides of the main sealant and the active area.

In an embodiment, the display panel further includes at least one effective circuit disposed in the peripheral circuit area of the lower substrate, and the at least one effective circuit is a fan-out circuit.

In an embodiment, the lower substrate is essentially covered by the upper substrate in a range of about 90% to about 95% of the area of the lower substrate.

In an embodiment, the display apparatus further includes a bezel disposed above the upper substrate and out of the active area. The supporting sealant is disposed in the sealed area corresponding to an edge of the bezel to support the upper substrate and the bezel.

In an embodiment, the shape of the sealed area formed by the main sealant is similar to the shape of the active area, and the at least one side of the main sealant corresponds to the fan-out circuit disposed in the peripheral circuit area.

In an embodiment, the distance between the at least one side of the main sealant and the active area is larger than the distances between the other sides of the main sealant and the active area.

In an embodiment, both the shapes of the sealed area and the active area are quadrilateral.

In an embodiment, the supporting sealant is adjacent to the at least one side of the main sealant and located between the active area and the at least one side of the main sealant.

In an embodiment, the shape of the sealed area formed by the main sealant has at least one more oblique angle than the shape of the active area.

In an embodiment, the at least one more oblique angle of the main sealant is a corner adjacent to the supporting sealant.

In an embodiment, the shape of the active area is quadrilateral, and the shape of the sealed area is hexagonal or octagon.

In an embodiment, the supporting sealant is plural and equidistantly arranged.

In an embodiment, the equidistantly arranged supporting sealant is parallel to a side of the main sealant adjacent to the supporting sealant.

In an embodiment, the length of the supporting sealant is 2 mm˜8 mm.

The advantage and spirit of the invention may be understood by the following detailed descriptions together with the appended drawings.

### BRIEF DESCRIPTION OF THE APPENDED DRAWINGS

FIG. 1 illustrates a schematic diagram of the sealed area formed out of the active area by the main sealant of the liquid crystal display and the exposed effective circuit.

FIG. 2 illustrates a cross-sectional view of the liquid crystal display of FIG. 1 along the A-A′ direction.

FIG. 3 illustrates a schematic diagram of the display apparatus in a preferred embodiment of the invention.

FIG. 4 illustrates a cross-sectional view of the liquid crystal display of FIG. 3 along the B-B′ direction.

FIG. 5 illustrates a schematic diagram of the shape of the sealed area having two more oblique angles than the shape of the active area.

FIG. 6 illustrates a schematic diagram of longer supporting sealants disposed in the sealed area.

FIG. 7 illustrates a schematic diagram that too long supporting sealants retarding the diffusion of the liquid crystals.

FIG. 8 illustrates a schematic diagram of more supporting sealants disposed in the sealed area.

### DETAILED DESCRIPTION OF THE INVENTION

The invention provides a display apparatus having different sealant coating designs to reduce the exposed area of effective circuit to prevent the circuit from being damaged and to avoid the ripple shown in the display screen. Please refer to FIG. 1. FIG. 1 illustrates a schematic diagram of the sealed area formed out of the active area by the main sealant of the liquid crystal display and the exposed effective circuit.

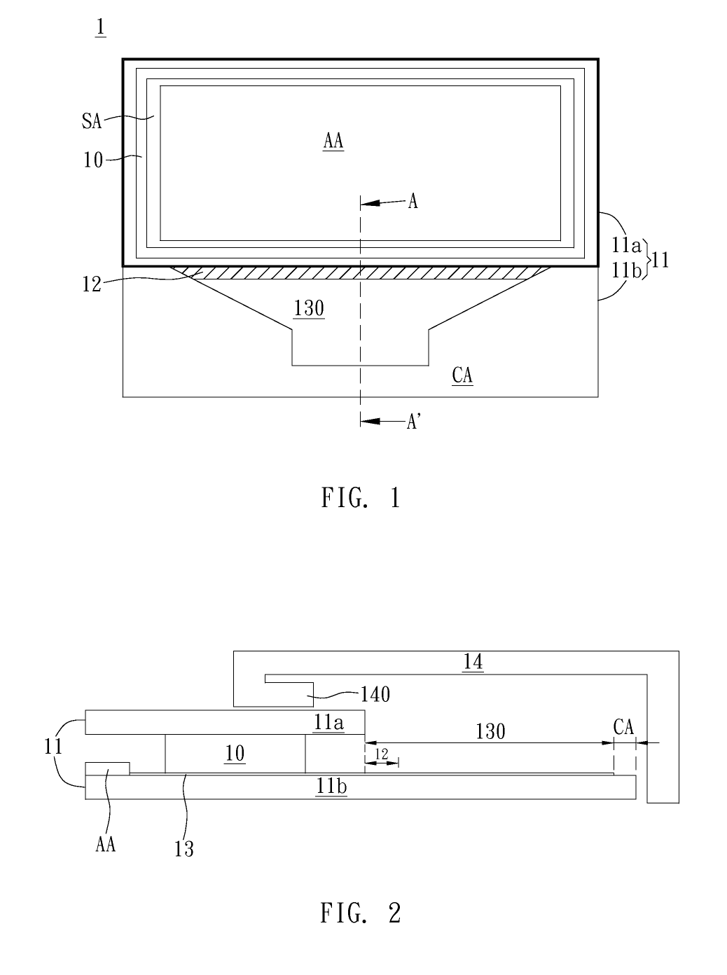

As shown in FIG. 1, in the liquid crystal display 1, the main sealant 10 is coated out of an active area AA on the lower substrate 11b of the display panel 11 to form a sealed area SA. The sealed area SA is all-around symmetrical to the active area AA. Please also refer to FIG. 2. FIG. 2 illustrates a cross-sectional view of the liquid crystal display of FIG. 1 along the A-A′ direction. As shown in FIG. 2, the bezel 14 is disposed above an edge of the upper substrate 11a of the display panel 11, and a medial edge 140 of the bezel 14 must press on the main sealant 10 to avoid ripples shown in the display screen of the liquid crystal display 1. It should be noticed that all area out of the active area AA on the lower substrate 11b is called a peripheral circuit area CA.

Because a part of an effective circuit 13 in the peripheral circuit area CA, such as a fan-out circuit, is not covered by the sealed area SA, the part of the effective circuit 13 will be exposed without any protection to form the exposed area 130 of effective circuit 13. As shown in the shaded area of FIG. 1, the easy-damaged area 12 is the area which is easily damaged to generate line defects in the exposed area 130 of effective circuit 13.

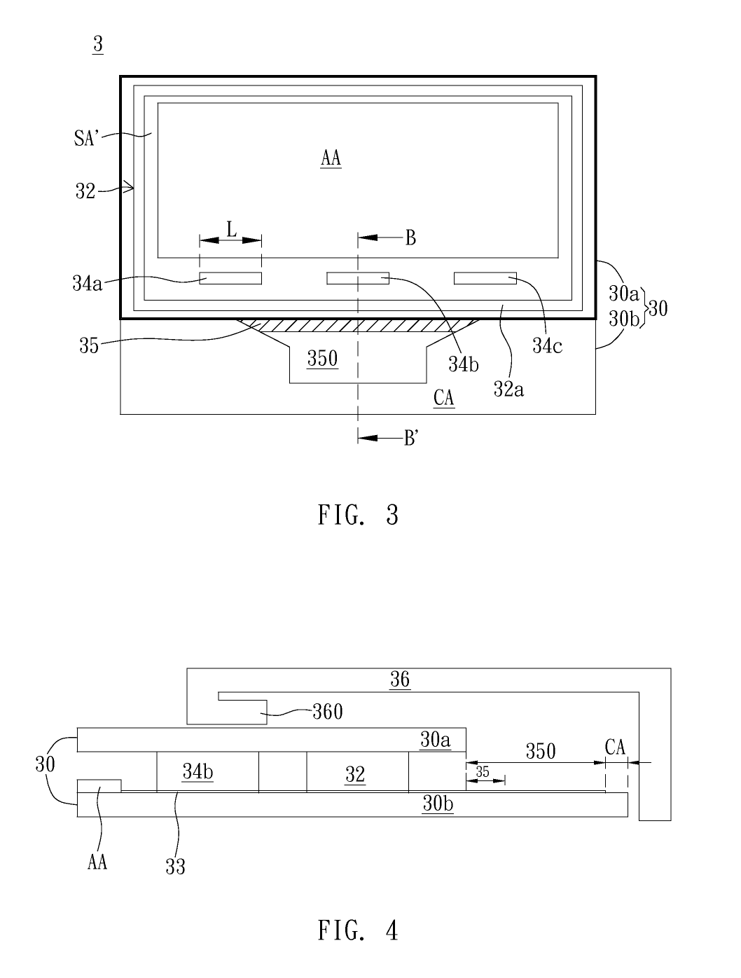

An embodiment of the invention is a display apparatus. In this embodiment, the display apparatus includes a liquid crystal display apparatus. Please refer to FIG. 3 and FIG. 4. FIG. 3 illustrates a schematic diagram of the display apparatus in a preferred embodiment of the invention; FIG. 4 illustrates a cross-sectional view of the liquid crystal display of FIG. 3 along the B-B′ direction.

As shown in FIG. 3 and FIG. 4, the display apparatus 3 includes a display panel 30 and a bezel 36. The display panel 30 includes an upper substrate 30a, a lower substrate 30b, a main sealant 32, and supporting sealants 34a˜34c. The lower substrate 30b of the display panel 30 has an active area AA and a peripheral circuit area CA adjacent to the active area AA. For example, the peripheral circuit area CA surrounds the active area AA. At least one effective circuit, such as a fan-out circuit 33, is disposed in the peripheral circuit area CA of the lower substrate 30b. Therefore, the size of one side of the peripheral circuit area CA is larger than the sizes of the other three sides of the peripheral circuit area CA. The upper substrate 30a of the display panel 30 covers the active area AA and a part of the peripheral circuit area CA of the lower substrate 30b, wherein it is about 90%˜95% of the area of the lower substrate 30b covered by the upper substrate 30a. In this embodiment, the upper substrate 30a and the lower substrate 30b of the display panel 30 are respectively a color filter and a thin-film transistor substrate, but not limited to this.

The main sealant 32 is disposed between the upper substrate 30a and the lower substrate 30b. The main sealant 32 is disposed on the peripheral circuit area CA out of the active area AA to form a sealed area SA′. The sealed area SA′ covers the active area AA and a part of the peripheral circuit area CA. A part of the effective circuit in the peripheral circuit area CA, such as a part of the fan-out circuit 33, not covered by the sealed area SA′ is called the exposed area of effective circuit 350.

As shown in the shaded area of FIG. 3, the easy-damaged area 35 is the area which is easily damaged to generate line defects in the exposed area of effective circuit 350. The shape of the sealed area SA′ formed by the main sealant 32 out of the active area AA is similar to the shape of the active area AA. In this embodiment, both the shapes of the sealed area SA′ and the active area AA are quadrilateral, but not limited to this.

It should be noticed that the difference between this embodiment and the display in FIG. 1 is that the distance between one side 32a of the main sealant 32, which corresponds to the fan-out circuit 33 of the peripheral circuit area CA, and the active area AA is different from the distances between the other sides of the main sealant 32 and the active area AA. That is to say, compared to the display in FIG. 1, the upper substrate 30a of the display panel 30 in FIG. 3 is enlarged and extended toward the direction of the fan-out circuit 33, and the side 32a of the main sealant 32 corresponding to the fan-out circuit 33 moves above the outer area of the fan-out circuit 33 with the enlarging of the upper substrate 30a; therefore, the area of the sealed area SA′ formed by the main sealant 32 out of the active area AA is larger than the area of the sealed area SA in FIG. 2. Because the sealed area SA′ will be also enlarged toward the direction of the peripheral circuit area CA, the area of the peripheral circuit area CA covered by the sealed area SA′ will become larger.

From the practical measured data, it can be found that the area percentage between the exposed area of effective circuit 130 and the area of the peripheral circuit area CA not covered by the upper substrate 11a in FIG. 1 is about 32.5%; the area percentage between the exposed area of effective circuit 350 and the area of the peripheral circuit area CA not covered by the upper substrate 30a in FIG. 3 is about 5.6%. It can be concluded that the area of the exposed area of effective circuit 350 in FIG. 3 is much smaller than the area of the exposed area of effective circuit 130 in FIG. 1, and the exposed peripheral circuit will be also reduced. Therefore, the easy-damaged area 35 easily damaged to generate line defects in the exposed area of effective circuit 350 in FIG .3 will be also smaller than the easy-damaged area 12 in FIG. 1.

In this embodiment, the display panel 30 further includes a plurality of supporting sealants 34a˜34c. The supporting sealants 34a˜34c are disposed in the sealed area SA′ and out of the active area AA. That is to say, the supporting sealants 34a˜34c are disposed between the side 32a of the main sealant 32 and the active area AA and parallel to the side 32a of the main sealant 32. In this embodiment, the supporting sealants 34a˜34c are equidistantly arranged, but not limited to this. In fact, the length L of the supporting sealants 34a˜34c in FIG. 3 is preferably in a range of about 2 mm˜8 mm, but not limited to this. In addition, the shape, length, and number of the supporting sealants 34a˜34c have no specific limitations and can be adjusted based on practical needs. As shown in FIG. 4, the bezel 36 is disposed above the upper substrate 30a and out of the active area AA. The supporting sealant 34b is disposed in the sealed area SA' corresponding to a medial edge 360 of the bezel 36 to support the upper substrate 30a and the bezel 36.

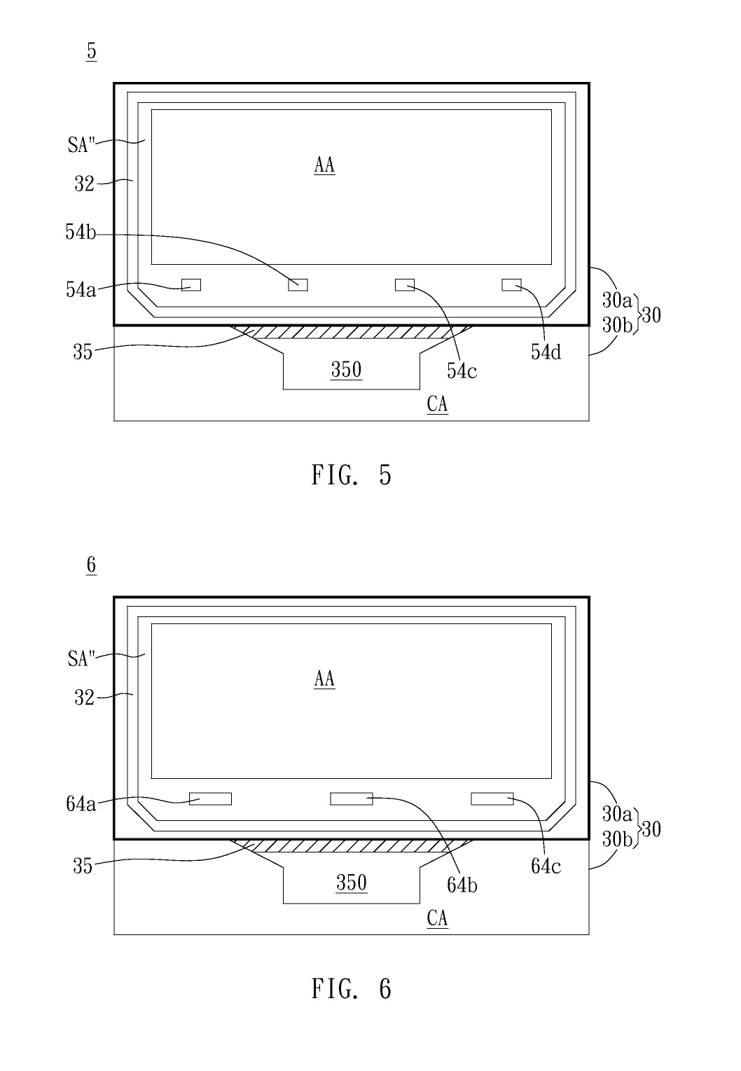

In other embodiments, the shape of the sealed area formed by the main sealant is unnecessary to be the same with the shape of the active area AA. The shape of the sealed area can have at least one more oblique angle than the shape of the active area AA. For example, as shown in FIG. 5, the shape of the active area AA is quadrilateral and the shape of the sealed area SA″ is hexagonal. That is to say, the shape of the sealed area SA″ has two more oblique angles than the shape of the active area AA, and the two oblique angles is the corners adjacent to the supporting sealants 54a˜54d. In addition, the shape of the sealed area SA″ can be octagon having four more oblique angles than the shape of the active area AA.

Next, the supporting sealant having different lengths and number disposed in the sealed area will be compared as follows.

Please refer to FIG. 5 and FIG. 6. The supporting sealants 64a˜64c in FIG. 6 and the supporting sealants 54a˜54d in FIG. 5 are all disposed in the sealed area SA″ and equidistantly arranged. The lengths of the supporting sealants 64a˜64c in FIG. 6 are all 6 mm larger than the lengths of the supporting sealants 54a˜54d in FIG. 5 which are all 3 mm. Although the lengths of the supporting sealants 64a˜64c in FIG. 6 are larger than the lengths of the supporting sealants 54a˜54d in FIG. 5, since the number of the supporting sealants 54a˜54d in FIG. 5 is larger than the number of the supporting sealants 64a˜64c in FIG. 6, the equidistantly arranged supporting sealants 54a˜54d in FIG. 5 and the equidistantly arranged supporting sealants 64a˜64c in FIG. 6 both can provide enough supporting force to the bezel disposed above to avoid the ripples shown in the screen of the display apparatus.

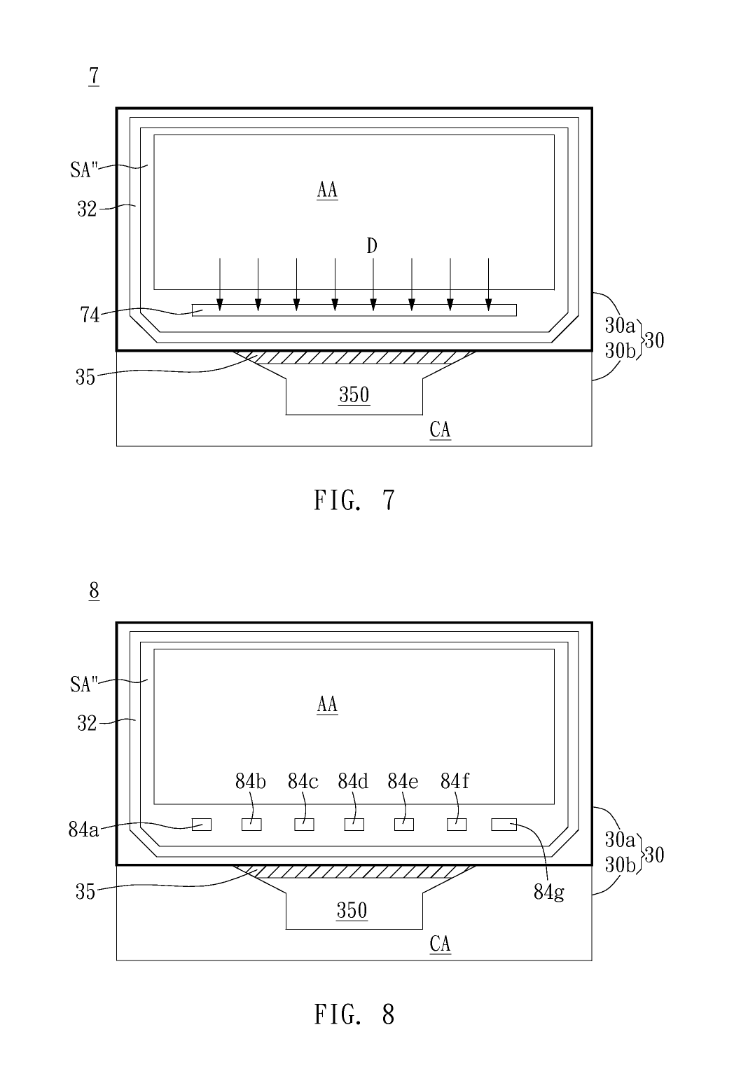

However, in practical applications, the length of the supporting sealant is not necessarily the longer the better. As shown in FIG. 7, only one supporting sealant 74 is disposed in the display apparatus 7, since it is very long (e.g., its length near to the width of the active area), it can provide strong supporting force to the bezel disposed above, but it may block the liquid crystal diffusion direction D and the diffusion of the liquid crystals will become harder.

In addition, as shown in FIG. 8, when a lot of supporting sealants 84a˜84g is disposed in the display apparatus 8, it can provide stronger supporting force to the bezel disposed above and have better liquid crystal diffusion condition than that shown in FIG. 7. However, it needs more start points and end points of the supporting sealants and wastes more time for the coating machine to coat the supporting sealants.

Compared to the prior art, the display apparatus of the invention has different sealant coating designs to reduce the exposed area of effective circuit to prevent the effective circuit from being damaged and to increase the reliability of the effective circuit. In addition, it can also avoid the ripples shown in the screen of the display apparatus to enhance the display quality of the display apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display apparatus, comprising:
a display panel comprising an upper substrate and a lower substrate, wherein the display panel has an active area and a peripheral circuit area adjacent to the active area, the display panel further comprises:
a main sealant, disposed between the upper substrate and the lower substrate, wherein the main sealant is out of the active area to form a sealed area, and the sealed area covers the active area and a part of the peripheral circuit area; and
at least one supporting sealant, disposed in the sealed area and out of the active area,
wherein the distance between at least one side of the main sealant and the active area is different from the distances between the other sides of the main sealant and the active area.

2. The display apparatus of claim 1, wherein the display panel further includes at least one effective circuit disposed in the peripheral circuit area of the lower substrate, and the at least one effective circuit is a fan-out circuit.

3. The display apparatus of claim 1, wherein the lower substrate is essentially covered by the upper substrate in a range of about 90% to about 95% of the area of the lower substrate.

4. The display apparatus of claim 1, further comprising a bezel disposed above the upper substrate and out of the active area, wherein the supporting sealant is disposed in the sealed area corresponding to an edge of the bezel to support the upper substrate and the bezel.

5. The display apparatus of claim 2, wherein the shape of the sealed area formed by the main sealant is similar to the shape of the active area, and the at least one side of the main sealant corresponds to the fan-out circuit disposed in the peripheral circuit area.

6. The display apparatus of claim 5, wherein the distance between the at least one side of the main sealant and the active area is larger than the distances between the other sides of the main sealant and the active area.

7. The display apparatus of claim 5, wherein both the shapes of the sealed area and the active area are quadrilateral.

8. The display apparatus of claim 5, wherein the supporting sealant is adjacent to the at least one side of the main sealant and located between the active area and the at least one side of the main sealant.

9. The display apparatus of claim 6, wherein the shape of the sealed area formed by the main sealant has at least one more oblique angle than the shape of the active area.

10. The display apparatus of claim 9, wherein the at least one more oblique angle of the main sealant is a corner adjacent to the supporting sealant.

11. The display apparatus of claim 6, wherein the shape of the active area is quadrilateral, and the shape of the sealed area is hexagonal or octagon.

12. The display apparatus of claim 1, wherein the supporting sealant is plural and equidistantly arranged.

13. The display apparatus of claim 12, wherein the equidistantly arranged supporting sealant is parallel to a side of the main sealant adjacent to the supporting sealant.

14. The display apparatus of claim 12, wherein the length of the supporting sealant is 2 mm˜8 mm.
